(19) United States
(12) Patent Application Publication
(10) Pub. No.: US 2007/0143615 A1
(43) Pub. Date: Jun. 21, 2007

(54) Method of generating a pin code based on target device class in wireless device pairing

(76) Inventors: Kari Hiitola, Tampere (FI); Kimmo Lahdensivu, Lempaala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/305,892

(22) Filed: Dec. 15, 2005

(51) Int. Cl. H04L 9/00

(52) U.S. Cl. 713/172; 709/226; 707/101

(57) ABSTRACT

The invention provides a method for a first device to establish a wireless communication connection with a second device. The first device receives from the second device a signal indicating a class of device of the second device, and generates a PIN code comprising a plurality of characters. The plurality of characters comprises at least one alphabet character if the class of device of the second device indicates such alphabet character can be entered in the second device, otherwise the plurality of characters comprises only numerical characters.

### TECHNICAL FIELD

The present invention pertains to wireless communications between two or more electronic devices. Particularly, the present invention relates to wireless communications according to BLUETOOTH® standards and establishing a communication link between two devices.

### BACKGROUND ART

BLUETOOTH® is an industrial specification for short-range wireless communication between two or more electronic devices. BLUETOOTH® provides a way to connect and exchange information between devices like personal digital assistants (PDAs), mobile phones, laptops computers, printers and digital cameras via a secure, low-cost, globally available short range radio frequency.

Under the BLUETOOTH® standards, an electronic device can initialize a connection (also called a pairing) with another electronic device when two devices are in a range of less than 10 meters (actual range of a device varies depending on device's power class). A BLUETOOTH® pairing procedure starts with a first device searching for other BLUETOOTH® enabled devices within range. All devices willing to be paired would respond to the search, and their presence is shown on the first device in terms of device address, device name, and class of device (usually represented by an icon). A user may select a second device from the list of devices for pairing. Upon selecting the second device, the first device prompts the user to enter a code in the first device. Then the second device prompts the user to enter the same code in the second device. This code is commonly known as a personal identification number (PIN) or a passcode. The latter is a non-technical term recommended to be used in user interfaces. The PIN code is encrypted to form a key, and the key is shared by the two devices to form a secure communication link (also called a trusted pair). For devices such as PDAs, mobile phones, and personal computers (PCs) that are normally equipped with a user interface, an identical PIN code must be entered in one device and then the other. If the second device does not have a user interface for entering the PIN code (such device includes printers and hands-free headsets), a PIN code pre-specified by the device manufacturer must be entered correctly in the first device.

FIG. 1 is a block diagram of the above-described BLUETOOTH® pairing method, assuming both the first device and the second device have user input means. In a step 110, a first device initiates a pairing procedure with a second device in response to a user's request (i.e. the user selects a device for pairing from a list of discovered devices). In a step 120, the first device prompts the user to input a PIN code. In a step 130, the first device receives a PIN code typed in by the user (e.g. 1234). In a step 140, the second device prompts the user to input a PIN code in the second device. In a step 150, the second device receives a PIN code that is identical to the one inputted in the first device (e.g. 1234). As the result, in a step 160, the first device and the second device establish a secure communication link (a trusted pair).

According to this method, a user needs to make up and enter a PIN code for use in both devices in order to form a pair. The use of the PIN codes is confusing to a user who is unfamiliar with the pairing process. Also, due to human nature and limitations, PIN codes made up by users tend to be too short or too easy to decipher. For the reasons given below, using such a PIN code may increase the risk of a device pairing up with an unauthorized device without user's knowledge.

Normally, once a trusted pair is formed, the authentication (pairing) process is not repeated next time the pair is in the range. However, it occurs sometimes that the pairing is interrupted and the user is forced to repeat the pairing procedure. As shown below, the interruption of the pairing could be a result of a third device attempting to make an unauthorized connection, and re-pairing could give the unauthorized device an opportunity to be paired with the first device.

Security risks in BLUETOOTH® pairing are discussed in some published documents. In August 2004, an experiment showed that with directional antennas, the range of class 2 BLUETOOTH® radio signals (nominal range 10 meters) could be extended to one mile. This enables an attacker to access a vulnerable BLUETOOTH® device from a distance far beyond the nominal range.

In June 2005, Yaniv Shaked and Avishai Wool of Tel Aviv University in Israel published a paper describing how to recover a PIN code by eavesdropping on the pairing process. The authors claim that they have figured out how to force a pair of BLUETOOTH® devices to repeat the pairing process, allowing an attacker to eavesdrop on it. An attacker's device pretends to be one of the two paired devices, and sends a message to the other claiming to have forgotten the link key, a code negotiated with the help of the PIN code for use in mutual authentication. This prompts the other device to discard the PIN code, and initiate a re-pairing procedure. During the re-pairing procedure, the attacker's device has an opportunity to crack the PIN code.

Many BLUETOOTH® device manufacturers set up a four-digit PIN code for the devices. The paper demonstrates that an attacker can crack a 4-digit PIN code in less than 0.3 sec on an old Pentium III 450 MHz computer, and in 0.06 sec on a Pentium IV 3 Ghz HT computer. (Source: Yaniv Shaked and Avishai Wool, “Cracking the Bluetooth PIN”, International Conference On Mobile Systems, Applications And Services, Proceedings of the 3rd International Conference on Mobile Systems, Applications, and Services, Pages 39-50, Seattle, Wash., 2005. ISBN: 1-931971-31-5)

Since BLUETOOTH® is a wireless technology, it is very difficult to avoid radio signals from leaking outside the desired boundaries. To increase pairing security, the PIN code should be set as difficult for an attacker to decipher as possible. In other words, it is always preferable to use long and random PIN codes as much as the devices may allow. In particular, pairing in public places carries higher risk than in private. Therefore, a long and complex PIN code should be used if pairing in public places is unavoidable.

One improvement in increasing BLUETOOTH® pairing security, which is already implemented in some BLUETOOTH® enabled devices (e.g. PCs with MICROSOFT® WINDOWS XP SP2's BLUETOOTH®0 stack), is to generate the PIN code automatically in the device that initiates the pairing process. A user only needs to enter the generated PIN code on the target device in order to form a pairing. However, the PIN code generation function of the software (e.g. the aforementioned BLUETOOTH® stack) on the device does not take into account the type of the target device, and the generated PIN codes are always in pure numeric format (and in fixed length).

FIG. 2 is a prior art BLUETOOTH® pairing method with automatic PIN code generation. In a step 210, a first device (the pairing device) initiates a pairing procedure with a second device (the target device) in response to a user's request. In a step 220, the first device displays an automatically generated PIN code on its display means. The generated PIN code is a pure numeric code (e.g. 91235123) with a fixed length. At a step 230, a second device prompts the user to enter the same PIN code displayed on the first device. At a step 240, the second device receives the PIN code. If the entered PIN code is 1 0 identical to the generated PIN code on the first device, at a step 250, the first devices and the second device establish a secure communication link (a trusted pair).

The ability of automatically generating PIN codes varies from one type of software to another. For example, as mentioned before, a personal computer equipped with MICROSOFT WINDOWS® XP SP2's BLUETOOTH® stack can generate a PIN code automatically, but it always generates a numeric PIN code. NOKIA® PC Suite's Connection Manager is able to “generate” a PIN code, but the code is always “123”.

A PIN code can be a 128-bit data string. According to the BLUETOOTH® 1.2 specification, Vol. 3, Part C, Chapter 3.2.3, a PIN code is encoded as UTF-8, which means the numeric characters (0-9) and the most common alphabetic characters (a-z, A-Z, $, #, @ etc.) each takes one byte. Therefore, a PIN code can contain up to 16 ASCII characters.

Generally, security level of a PIN code is proportional to the required calculation time by a computer to guess all the possible PIN codes in order to crack the PIN code. The longer the calculation time, the higher the security level of the PIN code. Using alphanumeric PIN codes increases the number of different PIN codes possible-therefore increases the calculation time-without added efforts in inputting the codes. For example, the security level of an alphanumeric PIN code of 5 characters is roughly equivalent to the security level of a numeric PIN code of 8 digits.

In reality, different types of devices can accept different kinds of PIN codes. For example, an alphanumeric code can be input in computer-type devices that come with an alphanumerical keypad. Mobile phones normally can only accept pure numeric PIN codes. For improving pairing security, alphanumeric PIN codes should be used whenever possible and a PIN code generator should be able to generate both types of codes. Further, it is also desirable that the length of a PIN code can be automatically adjusted depending on the type of the target device. For example, both PDAs and desktop computers have the capability of accepting alphanumeric PIN codes, but it is easier to type with a desktop computer than with a PDA. Therefore, a user may wish to use, e.g. a 12-character alphanumeric PIN code for a computer, and an 8-character alphanumeric PIN code for a PDA.

### SUMMARY OF THE INVENTION

The invention relates to a method for a first device to establish a communication connection with a second device.

In a first aspect of the invention, a method is provided. The method comprises the steps of receiving from the second device a signal indicating a class of device of the second device, and generating a code comprising a plurality of characters. The plurality of characters comprises at least one alphabet character if the class of device of the second device indicates such alphabet character can be entered in the second device, otherwise the plurality of characters comprises only numerical characters. Number of the plurality of characters depends on the major class of device and/or the minor class of device of the second device.

In a second aspect of the invention, a computer program product is provided. The computer program product comprises instruction for receiving from the second device a signal indicating a class of device of the second device, and instructions for generating a code comprising a plurality of characters. The plurality of characters comprises at least one alphabet character if the class of device of the second device indicates such alphabet character can be entered in the second device, otherwise the plurality of characters comprises only numerical characters.

In a third aspect of the invention, a wireless communication system, comprising a first device and a second device, is provided. The first device comprises means for receiving from the second device a signal indicating a class of device of the second device, and means for generating a code comprising a plurality of characters. The plurality of characters comprises at least one alphabet character if the class of device of the second device indicates such alphabet character can be entered in the second device, otherwise the plurality of characters comprises only numerical characters. The second device comprises means for transmitting a signal indicating a class of device of the second device.

In a forth aspect of the invention, a wireless device is provided. The wireless device is capable for establishing a wireless communication connection with a second wireless device. It comprises means for receiving from the second device a signal indicating a class of device of the second device, and means for generating a code comprising a plurality of characters. The plurality of characters comprises at least one alphabet character if the class of device of the second device indicates such alphabet character can be entered in the second device, otherwise the plurality of characters comprises only numerical characters.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a flow diagram of prior art BLUETOOTH® pairing method with manual PIN code input,

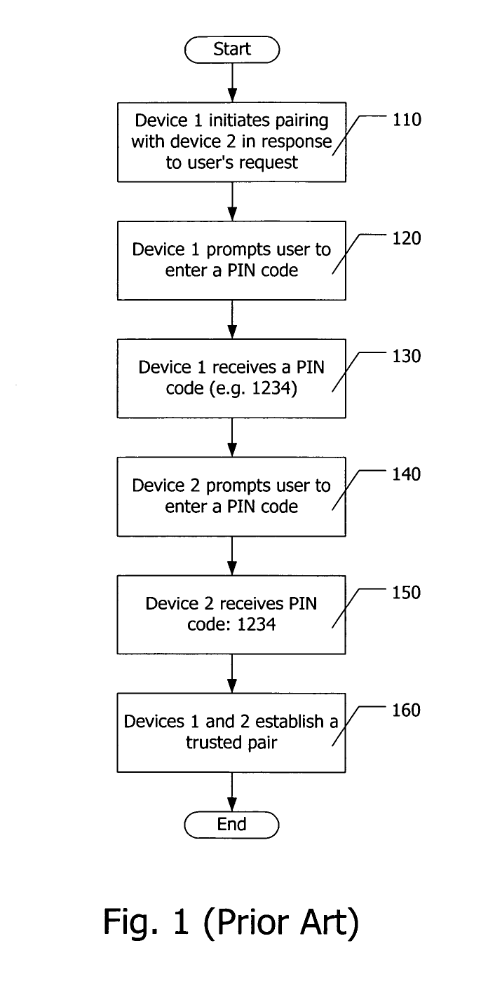

FIG. 2 is a flow diagram of prior art numeric PIN code generation in BLUETOOTH® pairing,

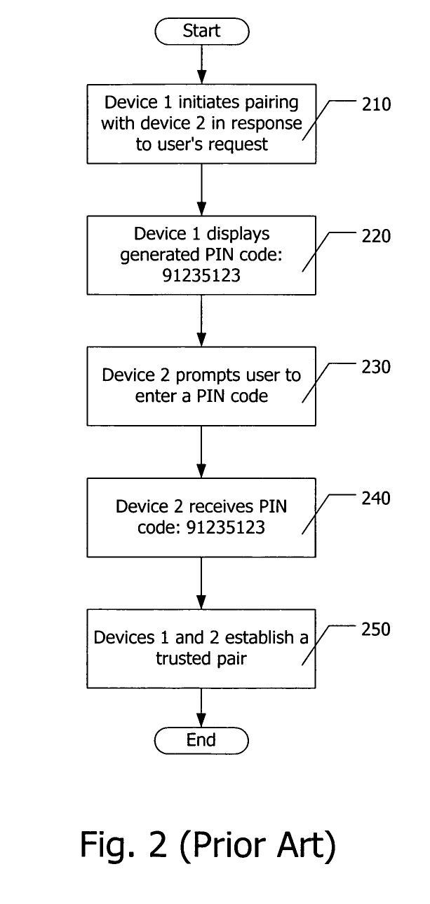

FIG. 3 is a data structure of a Class of Device (CoD) record,

FIG. 4 is a flow diagram of the BLUETOOTH® pairing method according to the first embodiment of the invention, and

FIG. 5 is a flow diagram of the BLUETOOTH® pairing method according to the second embodiment of the invention.

### DETAILED DESCRIPTION OF THE INVENTION

As mentioned before, even before the BLUETOOTH® pairing procedure is performed, the device address, device name, and class of device information of the discoverable devices are already known. Every device has a 24-bit class identifier called Class of Device (CoD). This identifier contains parameters indicating the device's major class and minor class, for example, major class “Computer,” minor class “Laptop,” or major class “Phone,” minor class “Smart phone,” etc. The major and minor device classifications are kept in a device's storage means, and icons representing device class of discovered devices are generated and displayed based on the classification.

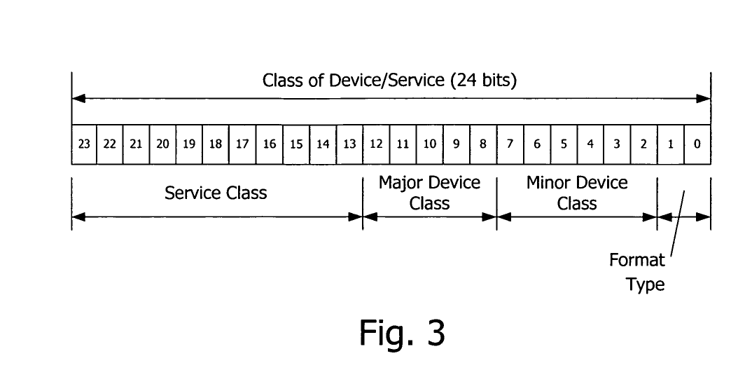

The formats of the CoD record are defined by the BLUETOOTH® specification in the BLUETOOTH® Assigned Numbers document. For example, as shown in FIG. 3, in a “format #1” of the CoD (Format Type field =00), 11 bits (bit no. 13-23) are assigned to a generic category of service class. The remaining 11 bits are used to indicate device type category and other device-specific characteristics.

The Major Device Class segment (bit nos. 8-12) indicates the device's major class. Thirty-two different major classes can be defined within the segment, but only nine of them are currently used. The assignment of this Major Class field is shown in Table 1.

TABLE 1
Major Device Classes

| Bit No. of CoD | | | | | |
|---|---|---|---|---|---|
| 12 | 11 | 10 | 9 | 8 | Major Device Class |
| 0 | 0 | 0 | 0 | 0 | Miscellaneous |
| 0 | 0 | 0 | 0 | 1 | Computer (desktop, notebook, PDA, |
| | | | | | organizers, . . .) |
| 0 | 0 | 0 | 1 | 0 | Phone (cellular, cordless, payphone, modem, . . .) |
| 0 | 0 | 0 | 1 | 1 | LAN/Network Access point |
| 0 | 0 | 1 | 0 | 0 | Audio/Video (headset, speaker, stereo, video |
| | | | | | display, VCR, . . .) |
| 0 | 0 | 1 | 0 | 1 | Peripheral (mouse, joystick, keyboards, . . .) |
| 0 | 0 | 1 | 1 | 0 | Imaging (printing, scanner, camera, display, . . .) |
| 0 | 0 | 1 | 1 | 1 | Wearable |
| 1 | 1 | 1 | 1 | 1 | Uncategorized, specific device code not specified |
| x | x | x | x | x | All other values reserved |

A major device class is further divided into several minor device classes, and this is indicated in the “Minor Device Class” segment (bit nos. 7 to 2). For example, the Computer major class is further divided into desktop, sever, laptop, etc. Table 2 lists minor device classes of the major device class “Computer.”

TABLE 2
Minor Device Classes for Computer Major Device Class

| Bit No. of CoD | | | | | | |
|---|---|---|---|---|---|---|
| 7 | 6 | 5 | 4 | 3 | 2 | Minor Device Class |
| 0 | 0 | 0 | 0 | 0 | 0 | Uncategorized, code for device not assigned |
| 0 | 0 | 0 | 0 | 0 | 1 | Desktop workstation |
| 0 | 0 | 0 | 0 | 1 | 0 | Server-class computer |
| 0 | 0 | 0 | 0 | 1 | 1 | Laptop |
| 0 | 0 | 0 | 1 | 0 | 0 | Handheld PC/PDA (clam shell) |
| 0 | 0 | 0 | 1 | 0 | 1 | Palm sized PC/PDA |
| 0 | 0 | 0 | 1 | 1 | 0 | Wearable computer (Watch sized) |
| 0 | x | x | x | x | x | All other values reserved |

Minor device classes of other major device classes, such as phone, LAN/network access point, audio/video, etc. are similarly defined. For complete device class specifications, see relevant documents posted on the World Wide Web (WWW) site of the Official BLUETOOTH® Membership.

With the information of major and minor classes of the second (target) device available, it is possible for a first device to generate a PIN code that is adapted to the class type of the second (target) device.

### FIRST EMBODIMENT OF THE INVENTION

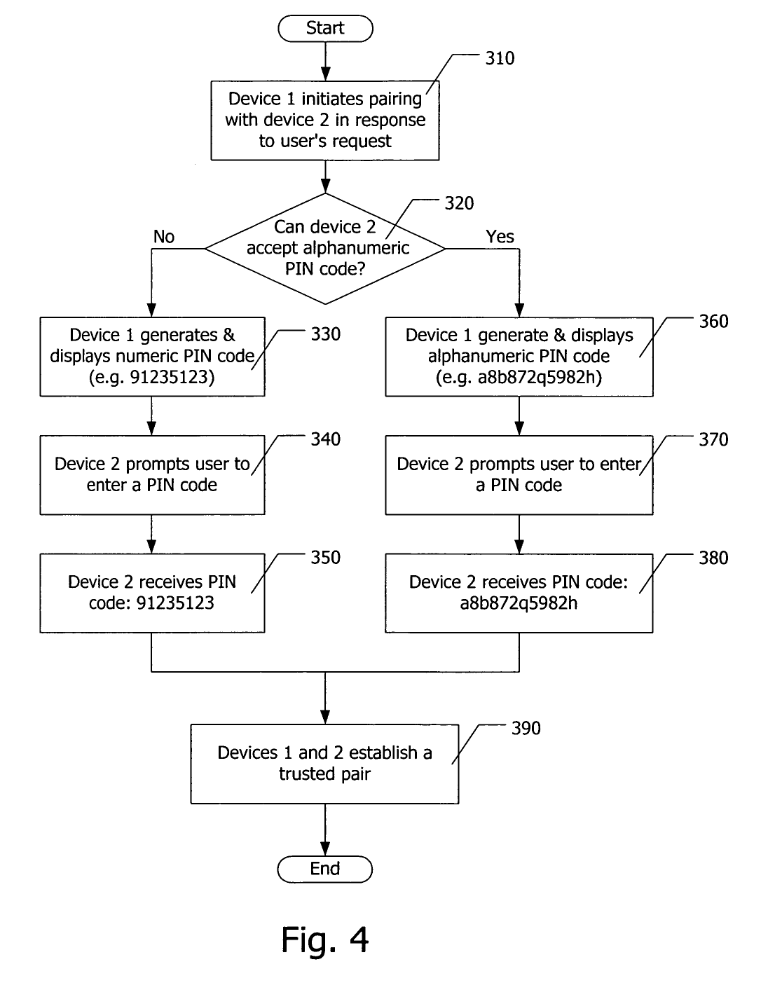

The first embodiment of the invention is shown in FIG. 4. In a step 310, a first device initiates a BLUETOOTH® pairing with a second device in response to a user's request. In a step 320, the first device determines whether the second device can accept an alphanumeric PIN code or a numeric PIN code based on the device class parameters (i.e. major device class and minor device class) it received from the second device. If a major device class parameter or a minor device class parameter indicates that the second device may have a keypad for input numerical characters but not a keypad for inputting alphabet characters, a numeric PIN code is generated by the first device. In a step 330, the first device generates a random numeric PIN code (e.g. 91235123). The generated numeric PIN code is at least four digits long, preferably at least eight digits long. In a step 340, the second device prompts the user to enter the PIN code generated by the first device. In a step 350, the second device receives the PIN code entered by the user (e.g. 91235123). In a step 390, if the PIN code is entered correctly, the first devices and the second device establish a trusted pair.

If the major device class parameter or the minor device parameter indicates, on the other hand, that the second device may have a keypad for inputting alphabet characters (for example if the second device is a computer), in a step 360, the first device generates an alphanumeric code (e.g. a8b872q5982h). In a step 370, the second device prompts the user to enter the PIN code generated by the first device. In a step 380, the second device receives the PIN code entered by the user. In a step 390, if the PIN code is entered correctly, the two devices are paired.

### SECOND EMBODIMENT OF THE INVENTION

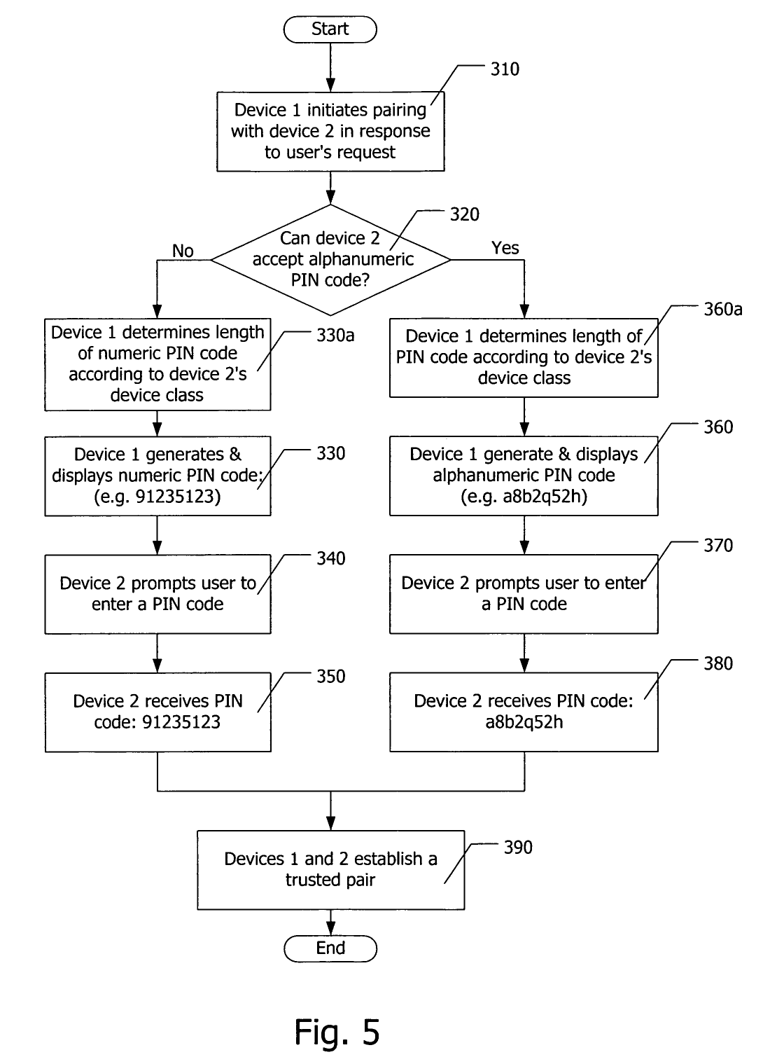

The second embodiment of the invention includes all the steps of the first embodiment of the invention, and additional steps in determining the length of the generated PIN code. The second embodiment of the invention is shown in FIG. 5. In a step 310, a first device initiates a BLUETOOTH® pairing with a second device in response to a user's request. In a step 320, the first device determines whether the second device can accept an alphanumeric PIN code or a numeric PIN code based on the device class parameters it received from the second device. If a major device class parameter or a minor device class parameter indicates that the second device may have a keypad for input numerical characters but not a keypad for inputting alphabet characters, a numeric PIN code is generated by the first device. In a step 330a, the first device determines how many digits of a numeric PIN code it should generate based on the major or minor device class parameter of the second device. In a step 330, the first device generates a random numeric PIN code (e.g. 91235123). The length of the PIN code is adjusted based on the major or minor device class parameter of the second device. Preferably, the generated numeric PIN code is at least four digits long. More preferably, the generated numeric PIN code is at least eight digits long. In a step 340, the second device prompts the user to enter the PIN code generated by the first device. In a step 350, the second device receives the PIN code entered by the user (e.g. 91235123). In a step 390, if the PIN code is entered correctly, the two devices are paired.

If the major device class parameter or the minor device parameter indicates, on the other hand, that the second device may have a keypad for inputting alphabet characters, for example if the device is a computer, the first device generates an alphanumeric PIN code. In a step 360a, the first device determines how many characters of the PIN it should generate based on the major or minor device class of the second device. For example it may generate an 8-character alphanumeric code “a8b2q52h” if the second device is a PDA, or a 12-character alphanumeric code if the second device is a laptop computer. In a step 370, the second device prompts the user to enter the PIN code generated by the first device. In a step 380, the second device receives the PIN code entered by the user. In a step 390, if the PIN code is entered correctly, the two devices are paired.

In the above embodiments of the invention, it is assumed that the second device has user input means for inputting the PIN code. If the CoD identifier of the second device indicates that the second device does not allow for entering an automatically generated PIN code, the user is prompted by the first device to enter a PIN code manually according to the instructions for using the second device.

A computer program product implementing the invention comprises a computer readable storage structure embodying program code for a first device to establish a wireless communication connection with a second device. The program code includes instructions for the first device to generate a first PIN code, either numeric or alphanumeric, and in variable length, depending on the at least one of Class of Device parameters of the second device. The program code also includes instructions for the first device to compare the first PIN code with a second PIN code entered in the second device and establish the communication connection if the second PIN code matches the first PIN code.

The program code may also include other functionalities. For example, if the first device is equipped with a user interface with display and input means, an option may be given to the user to input a customized PIN code, which overrides the automatic generated PIN codes. The program may also include short instructions for entering the PIN code, and preferably, a message is displayed warning the user of security risks if a too short or too obvious PIN code is used (especially in public places).

It is to be understood that the above-described arrangements are only illustrative of principles of the present invention. Although the invention has been described and illustrated with respect to exemplary embodiment thereof, the foregoing and various other additions and omissions may be made therein without departing from the spirit and scope of the present invention, and the appended claims are intended to cover such modifications and arrangements.

What is claimed is:

1. A method for a first device to establish a communication connection with a second device, comprising the steps of:
receiving from the second device a signal indicating a class of device of the second device, and
generating a code comprising a plurality of characters,
wherein the plurality of characters comprises at least one alphabet character if the class of device of the second device indicates such alphabet character can be entered in the second device, and otherwise comprises only numerical characters.

2. The method of claim 1, wherein the signal indicating the class of device includes a major class of device and a minor class of device of the second device.

3. The method of claim 2, wherein number of the plurality of characters depends on the major class of device and/or the minor class of device of the second device.

4. The method of claim 1, wherein the plurality of characters is at least four in number.

5. The method of claim 1, wherein the step of generating a code comprises generating a random code comprising a plurality of characters.

6. A computer program product, comprising a computer readable storage structure embodying computer program code thereon for a first device to establish a communication connection with a second device, wherein said computer program code comprises:
instruction for receiving from the second device a signal indicating a class of device of the second device, and
instructions for generating a code comprising a plurality of characters,
wherein the plurality of characters comprises at least one alphabet character if the class of device of the second device indicates such alphabet character can be entered in the second device, and otherwise comprises only numerical characters.

7. A wireless communication system, comprising a first device and a second device, wherein the first device comprises:
means for receiving from the second device a signal indicating a class of device of the second device, and
means for generating a code comprising a plurality of characters,
wherein the plurality of characters comprises at least one alphabet character if the class of device of the second device indicates such alphabet character can be entered in the second device, and otherwise comprises only numerical characters,
and wherein the second device comprises means for transmitting a signal indicating a class of device of the second device.

8. A device, capable for establishing a wireless communication connection with a second device, comprising:
means for receiving from the second device a signal indicating a class of device of the second device, and
means for generating a code comprising a plurality of characters,
wherein the plurality of characters comprises at least one alphabet character if the class of device of the second device indicates such alphabet character can be entered in the second device, and otherwise comprises only numerical characters.
